(19) United States
(12) Patent Application Publication
(10) Pub. No.: US 2013/0234979 A1
(43) Pub. Date: Sep. 12, 2013

(54) TOUCH CELL APPLIED TO CAPACITIVE TOUCH PANEL AND ASSOCIATED CAPACITIVE TOUCH PANEL

(71) Applicant: HIMAX TECHNOLOGIES LIMITED, Tainan City (TW)

(72) Inventors: Jui-Ni Lee, Tainan City (TW); Sheng-Fan Yang, Tainan City (TW); Yaw-Guang Chang, Tainan City (TW); Shen-Feng Tai, Tainan City (TW); Cheng-Feng Hsieh, Tainan City (TW)

(73) Assignee: HIMAX TECHNOLOGIES LIMITED, Tainan City (TW)

(21) Appl. No.: 13/684,167

(22) Filed: Nov. 22, 2012

(30) Foreign Application Priority Data
Mar. 7, 2012 (TW) 101107628

(51) Int. Cl. G06F 3/044

(52) U.S. Cl. CPC G06F 3/044
USPC 345/174

(57) ABSTRACT

A touch cell applied to a capacitive touch panel includes a first electrode and a second electrode, where the first electrode is connected to a scan signal transmitting circuit of the capacitive touch panel, and is utilized for receiving a scan signal, and the second electrode is connected to a detecting circuit of the capacitive touch panel. In addition, the second electrode is not connected to the first electrode, the second electrode has a fish-bone pattern, and a width of a tail of branches of the fish-bone pattern is greater than a width of a head of the branches of the fish-bone pattern.

### BACKGROUND OF THE INVENTION

1. Field of the Invention

The present invention relates to a capacitive touch panel, and more particularly, to a touch cell of a capacitive touch panel having a fish-bone shaped electrode.

2. Description of the Prior Art

Please refer to FIG. 1, which is a diagram illustrating a portion of elements of a capacitive touch panel 100. Referring to FIG. 1, the capacitive touch panel 100 includes a scan signal transmitting circuit 110, a detecting circuit 120 and a plurality of touch cells 130 (FIG. 1 merely shows three touch cells of a channel), where the touch cell includes a first electrode 132 and a second electrode 134, and each of the first electrode 132 and the second electrode 134 has a triangular pattern (or a sawtooth pattern). In the operations of the capacitive touch panel 100, the scan signal transmitting circuit 110 transmits a scan signal Vs to the first electrode 132 of the touch cell 130, and the detecting circuit 120 immediately detects changes of a voltage of the second electrode 134 to obtain capacitance variation information of the touch cell 130, and the capacitance variation information of the touch cell 130 is used to determine whether a touch point is on the touch cell 130 or not. Because the operations of the capacitive touch panel 100 are known by a person skilled in this art, further descriptions are therefore omitted here.

However, in the operations of the touch panel 100, because a coupling capacitance between the first electrode 132 and the second electrode 134 of the touch cell 130 is small, a touch sensibility and a signal to noise ratio (SNR) of the touch panel 100 are not good.

### SUMMARY OF THE INVENTION

It is therefore an objective of the present invention to provide a capacitive touch panel whose touch cell has a fish-bone shaped electrode, to solve the above-mentioned problems.

According to one embodiment of the present invention, a touch cell applied to a capacitive touch panel includes a first electrode and a second electrode, where the first electrode is connected to a scan signal transmitting circuit of the capacitive touch panel, and is utilized for receiving a scan signal, and the second electrode is connected to a detecting circuit of the capacitive touch panel. In addition, the second electrode is not connected to the first electrode, the second electrode has a fish-bone pattern, and a width of a tail of branches of the fish-bone pattern is greater than a width of a head of the branches of the fish-bone pattern.

According to another embodiment of the present invention, a touch cell applied to a capacitive touch panel includes a first electrode and a second electrode, where the first electrode is connected to a scan signal transmitting circuit of the capacitive touch panel, and is utilized for receiving a scan signal, and the second electrode is connected to a detecting circuit of the capacitive touch panel. In addition, the second electrode is not connected to the first electrode, the second electrode has a fish-bone pattern, and there is no first electrode positioned between the lines and the braches of the fish-bone pattern nearest to the lines.

According to another embodiment of the present invention, a capacitive touch panel includes a scan signal transmitting circuit, a detecting circuit and a plurality of touch cells, where each of the touch cells includes a first electrode and a second electrode, where the first electrode is connected to the scan signal transmitting circuit of the capacitive touch panel, and is utilized for receiving a scan signal, and the second electrode is connected to the detecting circuit. In addition, the second electrode is not connected to the first electrode, the second electrode has a fish-bone pattern, and a width of a tail of branches of the fish-bone pattern is greater than a width of a head of the branches of the fish-bone pattern.

According to another embodiment of the present invention, a capacitive touch panel includes a scan signal transmitting circuit, a detecting circuit and a plurality of touch cells, where each of the touch cells includes a first electrode and a second electrode, where the first electrode is connected to the scan signal transmitting circuit of the capacitive touch panel, and is utilized for receiving a scan signal, and the second electrode is connected to the detecting circuit. In addition, the second electrode is not connected to the first electrode, the second electrode has a fish-bone pattern, and there is no first electrode positioned between the lines and the braches of the fish-bone pattern nearest to the lines.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a portion of elements of a capacitive touch panel.

FIG. 2 is a diagram illustrating a capacitive touch panel according to one embodiment of the present invention.

FIG. 3 is a diagram illustrating a touch cell according to another embodiment of the present invention.

FIG. 4 is a diagram illustrating a touch cell according to another embodiment of the present invention.

### DETAILED DESCRIPTION

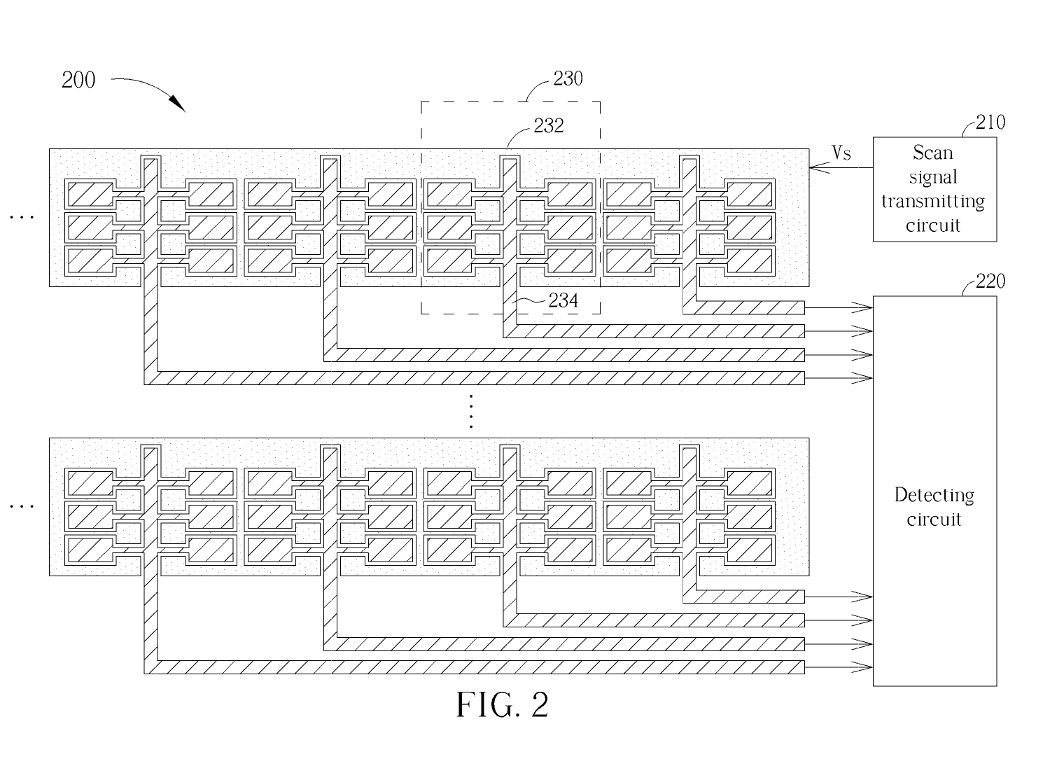

Please refer to FIG. 2, which is a capacitive touch panel 200 according to one embodiment of the present invention. As shown in FIG. 2, the capacitive touch panel 200 includes a scan signal transmitting circuit 210, a detecting circuit 220 and a plurality of touch cells 230, where each of the touch cells has a first electrode 232 and a second electrode 234, the second electrode 234 is not connected to the first electrode 232, the second electrode 234 has a fish-bone pattern, and a width of a tail of branches of the fish-bone pattern is greater than a width of a head of the branches of the fish-bone pattern. In addition, both the first electrode 232 and the second electrode 234 are indium tin oxide (ITO) electrodes fabricated in the same layer.

In addition, in the touch cell 230 shown in FIG. 2, the tail width of each of the branches of the fish-bone pattern is greater than the head width of the branch of the fish-bone pattern. However, in other embodiment of the present invention, the tail widths of only a portion of the branches of the fish-bone pattern is greater than the head widths of the branches of the fish-bone pattern, and the widths of the other braches can be uniform or be other designs. These alternative designs shall fall within the scope of the present invention.

In the operations of the capacitive touch panel 200, the scan signal transmitting circuit 210 transmits a scan signal Vs to the first electrode 232 of the touch cell 230, and the detecting circuit 220 immediately detects changes of a voltage of the second electrode 234 to obtain capacitance variation information of the touch cell 230, and the capacitance variation information of the touch cell 230 is used to determine whether a touch point is on the touch cell 230 or not. Because the operations of the scan signal transmitting circuit 210 and the detecting circuit 220 are known by a person skilled in this art, further descriptions are therefore omitted here.

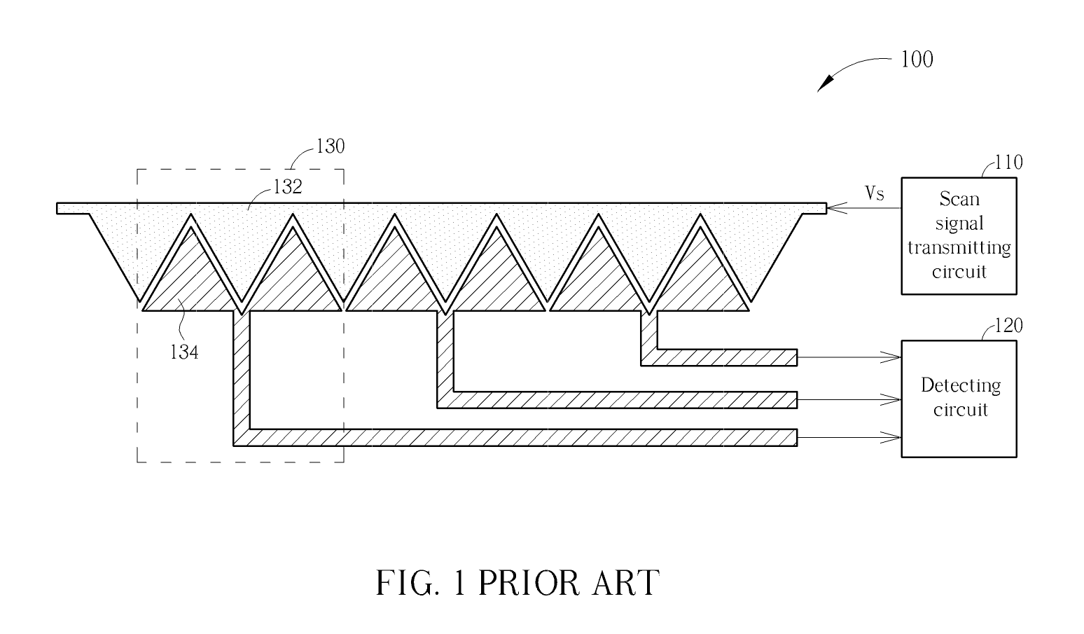

Referring to the touch cell 230 shown in FIG. 2, because the first electrode 232 and the second electrode 234 have a greater coupling area (i.e., a longer channel length between the first electrode 232 and the second electrode 234), the detecting circuit 220 will detect a larger coupling capacitance between the first electrode 232 and the second electrode 234, and it is meant that the touch sensibility and the SNR will be better. In detail, please refer to the following table that shows comparisons of measuring results of the prior touch cell 130 shown in FIG. 1 and the touch cell 230 shown in FIG. 2, the touch cell 230 has greater coupling capacitance, and a different between a coupling capacitance C_{non-touch} (i.e., no touch point is on the touch cell) and a coupling capacitance C_{touch} (i.e., a touch point is on the touch cell) of the touch cell 230 is also greater than that of the touch cell 130.

| | Coupling | Coupling | |
|---|---|---|---|
| | capacitance C_{non-touch} | capacitance C_{touch} | |
| | when no touch | when a touch | Difference |
| | point is on the | point is on the | between C_{non-touch} |
| | touch cell | touch cell | and C_{touch} |
| Prior art | 1.04 pF | 0.675 pF | 0.365 pF |
| touch cell | | | |
| 130 | | | |
| Touch cell | 2.13 pF | 1.672 pF | 0.458 pF |
| 230 | | | |

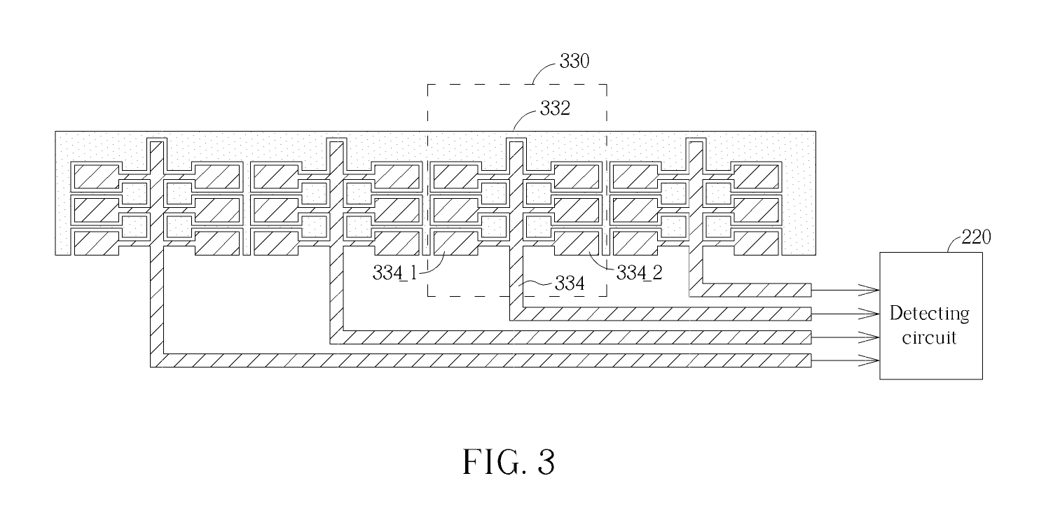

In addition, when a user uses the capacitive touch panel 200, the user's finger may be simultaneously put on many lines connected between the touch cells 230 and the detecting circuit 220. Therefore, the detecting circuit 220 may detect a little coupling capacitance variation even when there is no touch point on the touch cell 230, causing the error of detection. To solve this problem, in another embodiment of the present invention, the touch cell 230 of the touch panel 200 can be replaced by the touch cell 330 shown in FIG. 3, where the touch cell 330 includes a first electrode 332 and a second electrode 334, and there is no first electrode 332 positioned between branches of the fish-bone shaped second electrode 334, nearest to the lines connected to the detecting circuit 220, and the lines connected to the detecting circuit 220 (i.e., there is no first electrode 332 positioned between the branches (334_1 and 334_2) and the lines connected to the detecting circuit 220).

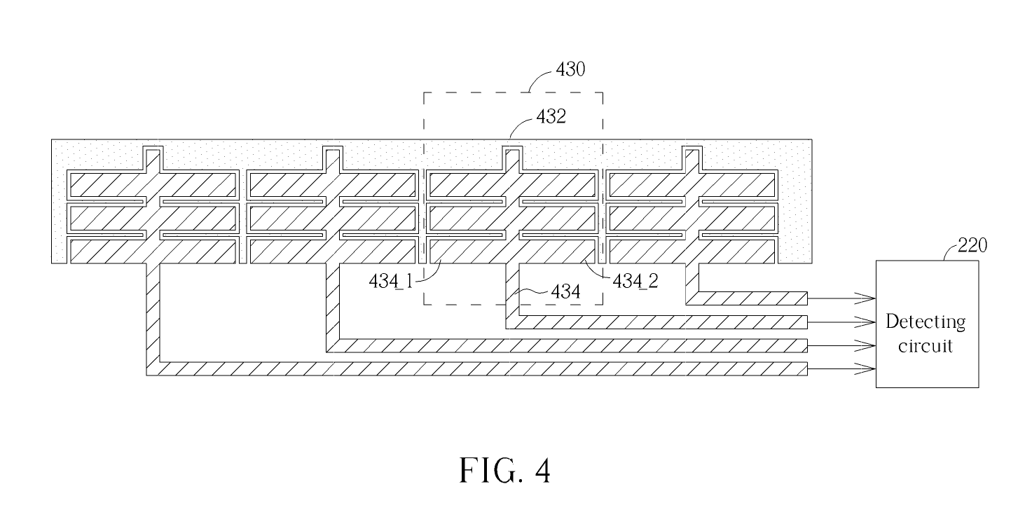

In addition, in another embodiment of the present invention, the touch cell 230 of the touch panel 200 can be replaced by the couch cell 430 shown in FIG. 4, where the touch cell 430 includes a first electrode 432 and a second electrode 434, and there is no first electrode 432 positioned between branches of the fish-bone shaped second electrode 434, nearest to the lines connected to the detecting circuit 220, and the lines connected to the detecting circuit 220 (i.e., there is no first electrode 432 positioned between the branches (434_1 and 434_2) and the lines connected to the detecting circuit 220).

In the touch cells 330 and 430 shown in FIG. 3 and FIG. 4, respectively, because there is no first electrode (332 and 432) positioned between the second electrode (334 and 434) and the lines, for each of the touch cell, the coupling capacitance between the second electrode of the touch cell and the lines connected between the other touch cells and the detecting circuit 220 can be decreased. Therefore, the detecting circuit 220 can determine the coupling capacitance more precisely.

It is noted that, the size, width, pitch and ratio of the first electrode and the second electrode shown in FIGS. 2-4 are for illustrative purposes only, and are not limitations of the present invention. In a practical design, the size, width, pitch and ratio of the first electrode and the second electrode can be determined according to a designer's consideration.

Briefly summarized, in the capacitive touch panel of the present invention, the touch cell includes a first electrode connected to a scan signal transmitting circuit and a second electrode connected to a detecting circuit, where the second electrode has a fish-bone pattern, and a width of a tail of branches of the fish-bone pattern is greater than a width of a head of the branches of the fish-bone pattern. In addition, in another embodiment, there is no first electrode positioned between the second electrode and a plurality of lines. Therefore, compared with the prior art technique, the capacitive touch panel of the present invention has better touch sensibility and the SNR.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch cell applied to a capacitive touch panel, comprising:
a first electrode, connected to a scan signal transmitting circuit of the capacitive touch panel, for receiving a scan signal; and
a second electrode, connected to a detecting circuit of the capacitive touch panel;
wherein the second electrode is not connected to the first electrode, the second electrode has a fish-bone pattern, and a width of a tail of branches of the fish-bone pattern is greater than a width of a head of the branches of the fish-bone pattern.

2. The touch cell of claim 1, wherein the detecting circuit connects to other touch cells of the capacitive touch panel via a plurality of lines, and there is no first electrode positioned between the lines and the braches of the fish-bone pattern nearest to the lines.

3. The touch cell of claim 1, wherein the first electrode and the second electrode are indium tin oxide (ITO) electrodes fabricated in a same layer.

4. A touch cell applied to a capacitive touch panel, comprising:
a first electrode, connected to a scan signal transmitting circuit of the capacitive touch panel, for receiving a scan signal; and
a second electrode, connected to a detecting circuit of the capacitive touch panel, wherein the detecting circuit connects to other touch cells of the capacitive touch panel via a plurality of lines;
wherein the second electrode is not connected to the first electrode, the second electrode has a fish-bone pattern, and there is no first electrode positioned between the lines and the braches of the fish-bone pattern nearest to the lines.

5. The touch cell of claim 4, wherein the first electrode and the second electrode are indium tin oxide (ITO) electrodes fabricated in a same layer.

6. A capacitive touch panel, comprising:
a scan signal transmitting circuit;
a detecting circuit; and
a plurality of touch cells, wherein each of the touch cells comprises:
a first electrode, connected to the scan signal transmitting circuit of the capacitive touch panel, for receiving a scan signal; and
a second electrode, connected to the detecting circuit;
wherein the second electrode is not connected to the first electrode, the second electrode has a fish-bone pattern, and a width of a tail of branches of the fish-bone pattern is greater than a width of a head of the branches of the fish-bone pattern.

7. The capacitive touch panel of claim 6, wherein the detecting circuit connects to other touch cells of the capacitive touch panel via a plurality of lines, and there is no first electrode positioned between the lines and the braches of the fish-bone pattern nearest to the lines.

8. The capacitive touch panel of claim 6, wherein the first electrode and the second electrode are indium tin oxide (ITO) electrodes fabricated in a same layer.

9. A capacitive touch panel, comprising:
a scan signal transmitting circuit;
a detecting circuit; and
a plurality of touch cells, wherein each of the touch cells comprises:
a first electrode, connected to the scan signal transmitting circuit of the capacitive touch panel, for receiving a scan signal; and
a second electrode, connected to the detecting circuit, wherein the detecting circuit connects to other touch cells of the capacitive touch panel via a plurality of lines;
wherein the second electrode is not connected to the first electrode, the second electrode has a fish-bone pattern, and there is no first electrode positioned between the lines and the braches of the fish-bone pattern nearest to the lines.

10. The capacitive touch panel of claim 9, wherein the first electrode and the second electrode are indium tin oxide (ITO) electrodes fabricated in a same layer.
